(19) United States
(12) Patent Application Publication
(10) Pub. No.: US 2008/0159755 A1
(43) Pub. Date: Jul. 3, 2008

(54) Optical signal receiving apparatus

(75) Inventor: Katsuhiko Hakomori, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/984,810

(22) Filed: Nov. 21, 2007

(30) Foreign Application Priority Data
Dec. 28, 2006 (JP) 2006-356379

(51) Int. Cl. H04B 10/06

(52) U.S. Cl. 398/202

(57) ABSTRACT

An optical signal receiving apparatus, able to detect a bit rate of a received signal by a low cost and able to change to a suitable reception band width corresponding to the received bit rate, provided with a bit rate detection circuit detecting a bit rate from a consumed current flowing through a CMOS inverter (CMOS-INV) connected to an output of a PIN photodiode converting an input optical signal to an electrical signal and a control circuit controlling a reverse bias voltage applied to a variable capacity diode provided at any location in the PIN photodiode or reception apparatus.

### CROSS-REFERENCE TO RELATED APPLICATIONS

This application is based on and claims a priority of Japanese Patent Application No. 2006-356379, filed Dec. 28, 2006, the contents being incorporated herein by reference.

### BACKGROUND OF THE INVENTION

1. Field of the Invention

The present invention relates to an optical signal receiving apparatus, more particularly relates to an optical signal receiving apparatus changing a reception band width in accordance with a received bit rate.

2. Description of the Related Art

At the present, optical fiber signal communication forms an important part of the social infrastructure and is fast becoming essential. Even in the general home, the areas of use of optical fiber transmission have increased greatly due to the increase in digital, broadband, and other services.

In the recent trunk optical communication systems, optical wavelength division multiplexing (WDM), optical signal switches, etc. have enabled various wavelengths of light to be handled in common by different facilities, so a high information transmission efficiency is maintained by a single fiber. These diverse wavelength optical signals include the conventional digital synchronous signals (SDH) and Ethernet® signals requiring Internet protocol. It is necessary to handle these different bit rate signals in real time. Such a communication system will become increasingly necessary in the future. Technology for increasing the communication capacity is therefore becoming necessary.

In the past, the multirate reception method of using a single optical communication device to receive optical signals of different wavelengths has been known. The receiving side frequency band in this case was fixed to the maximum band of the frequencies of the received signals.

FIG. 1 is a block diagram showing a conventional multirate optical communication system. In FIG. 1, 1 is an optical transmitting module, 2 an optical receiving module, and 3 an optical transmission path. Information input to the optical transmitting module changes in bit rate along with the time t to for example, 155 Mbit/sec, 2.4 Gbit/sec, and 622 Mbit/sec. Along with this, the data received by the optical receiving module 2 also changes in bit rate along with the time t to for example 155 Mbit/sec, 2.4 Gbit/sec, and 622 Mbit/sec.

As related art, there are Japanese Patent Publication (A) No. 2006-081141, Japanese Patent Publication (A) No. 09-233030, and Japanese Patent Publication (A) No. 08-331064.

FIG. 2 is a view showing the received band in the conventional optical receiving module 2. As shown in FIG. 2, in the past, the received band was constantly fixed so as to enable reception of the highest speed 2.4 Gbit/sec of the bit rates of the received signals. Therefore, when receiving a signal with a low bit rate, the received frequency band became too broad. For example, to receive data of 150 Mbit/sec, the band shown by the hatching in the figure is unnecessary. Input from this unnecessary band becomes noise. This noise accumulates. As a result, if the received frequency band is too broad, the SN ratio deteriorates and the minimum reception sensitivity deteriorates. Not only this, but also there was the problem that the tolerance against noise from the inside or outside became poor. To solve this problem, there were the following issues:

(1) It was necessary to detect the bit rate of the received signal, but there was no means for realizing this detection simply and at a low cost.

(2) The method is known of adding information regarding the bit rate to the transmitted signal instead of detecting the bit rate and receiving the signal by the received band corresponding to that bit rate at the receiving side, but with this method, there was the problem that only circuits specialized in transmission/reception could be used.

### SUMMARY OF THE INVENTION

An object of the present invention is to solve the above problems by providing at a low cost an optical signal receiving apparatus able to detect a bit rate of a received signal and change to a suitable reception band width corresponding to the received bit rate.

To achieve this object, according to a first aspect of the present invention, there is provided an optical signal receiving apparatus provided with a bit rate detection circuit detecting a bit rate by a consumed current flowing through a CMOS inverter connected to an output of a PIN photodiode converting an input optical signal into an electrical signal and a control circuit controlling a reverse bias voltage applied to the PIN photodiode based on the detected bit rate.

According to a second aspect of the present invention, there is provided an optical signal receiving apparatus provided with a variable capacity diode provided at any position in the optical signal receiving apparatus and a control circuit controlling the reverse bias voltage applied to the variable capacity diode based on a bit rate detected by a bit rate detection circuit detecting the size of a bit rate by a consumed current flowing through a CMOS inverter connected to the output of the optical signal receiving apparatus.

In the second aspect, there is provided an apparatus provided with a PIN photodiode or avalanche photodiode for converting an input optical signal to an electrical signal and having the variable capacity diode connected in parallel with the PIN photodiode or avalanche photodiode.

Instead of this, in the second aspect, it is also possible to provide an apparatus provided with a pre-amplifier amplifying an input signal and a post-amplifier amplifying an output of said pre-amplifier, where the variable capacity diode is connected between the outputs of the pre-amplifier and between the inputs of the post-amplifier.

According to a third aspect of the present invention, there is provided an optical signal receiving apparatus provided with a post-amplifier amplifying an output of a pre-amplifier amplifying an input signal, a variable capacity diode connected between the emitters of transistors inside a differential amplification circuit in the pre-amplifier or post-amplifier, and a control circuit controlling the reverse bias voltage applied to the variable capacity diode based on a bit rate detected by a bit rate detection circuit detecting a bit rate by a consumed current flowing through a CMOS inverter connected to the output of the optical signal receiving apparatus.

According to the fourth aspect of the present invention, there is provided an optical signal receiving apparatus provided with a post-amplifier amplifying an output of a pre-amplifier amplifying an input signal, a variable capacity diode connected to a collecter of a transistor in an operational amplification circuit in the pre-amplifier or post-amplifier, and a control circuit controlling a reverse bias voltage applied to the variable capacity diode based on a bit rate detected by a bit rate detection circuit detecting a bit rate by a consumed current flowing through a CMOS inverter connected to the output of the optical signal receiving apparatus.

In each aspect, by detecting the consumed current flowing through a CMOS inverter, it is possible to simply and inexpensively detect the bit rate of a received signal. By changing the capacity of the PIN photodiode or variable capacity diode in accordance with the detected bit rate, a suitable received band corresponding to the received bit rate is secured, so the minimum reception sensitivity can be improved and the tolerance against noise from the inside or outside can be improved.

### BRIEF DESCRIPTION OF THE DRAWINGS

These and other objects and features of the present invention will become clearer from the following description of the preferred embodiments given with reference to the attached drawings, wherein:

FIG. 1 is a block diagram showing a conventional multirate optical communication system;

FIG. 2 is a view showing a received band in a conventional optical receiving module;

FIG. 3A is a circuit diagram for explaining the principle of the bit rate detection method according to the present invention;

FIG. 3B is a block diagram showing the relationship between the consumed current flowing through the CMOS inverter and the bit rate of the input signal shown in FIG. 3A;

FIG. 3C is a graph showing the relationship between the input waveform and output waveform of the CMOS inverter shown in FIG. 3A and the consumed current;

FIG. 4A is a circuit diagram for explaining the change of a junction capacity in the case of applying a reverse bias voltage to a PIN photodiode in a first embodiment of the present invention;

FIG. 4B is a graph showing the relationship between a reverse bias voltage from a battery and a capacity of the junction capacity in the circuit shown in FIG. 4A;

FIG. 4C is a view showing a circuit provided with a pre-amplifier and PIN photodiode in a first embodiment of the present invention;

FIG. 5 is a view for explaining a means for changing the width of the frequency band applied to a second embodiment of the present invention;

FIG. 6 is a view for explaining a means for changing the width of the frequency band applied to a third embodiment of the present invention;

FIG. 7 is a view for explaining a means for changing the width of the frequency band applied to a fourth embodiment of the present invention;

FIG. 8A is a view for explaining a means for changing the width of the frequency band applied to a fifth embodiment of the present invention;

FIG. 8B is a graph for explaining the fact that the voltage applied to a control terminal is low and the band width falls;

FIG. 9 is a block diagram showing the change in control voltage for actually enabling multirate reception;

FIG. 10 is a circuit diagram showing the configuration of a multirate optical signal receiving apparatus including a circuit for changing the control voltage explained in FIG. 9 according to Example 1 of the present invention;

FIG. 11 is a circuit diagram showing the configuration of a multirate optical signal receiving apparatus including a circuit for changing the control voltage explained in FIG. 9 according to Example 2 of the present invention;

FIG. 12 is a circuit diagram showing the configuration of a multirate optical signal receiving apparatus including a circuit for changing the control voltage explained in FIG. 9 according to Example 3 of the present invention; and

FIG. 13 is a circuit diagram showing the configuration of a multirate optical signal receiving apparatus including a circuit for changing the control voltage explained in FIG. 9 according to Example 5 of the present invention.

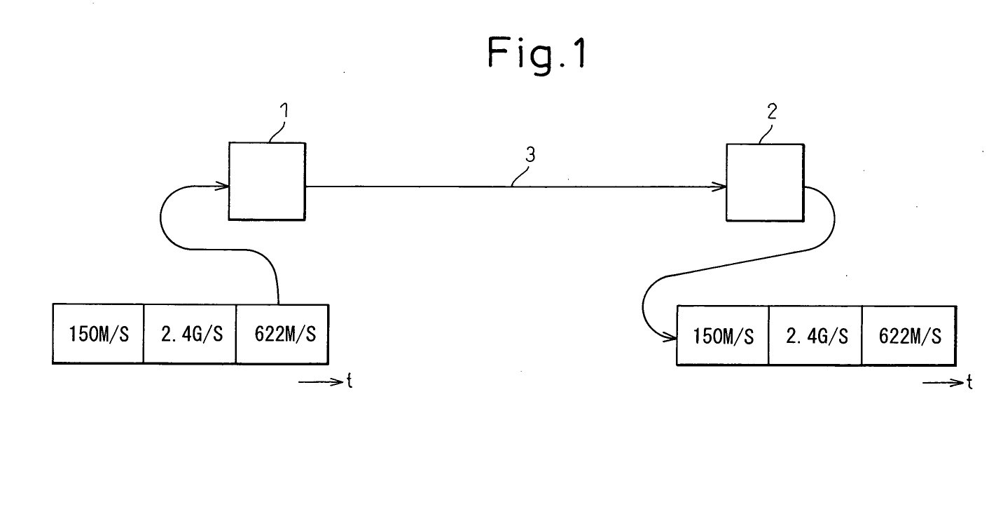

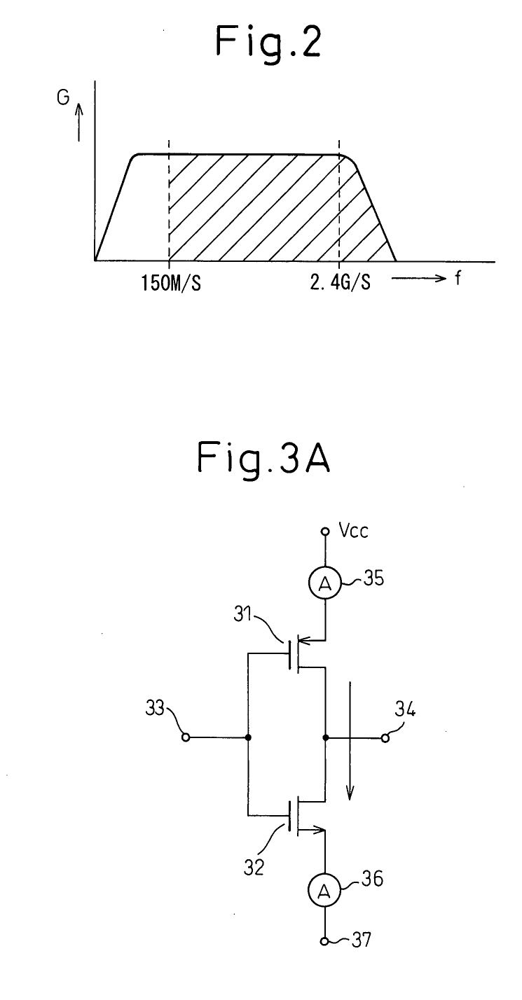

### DESCRIPTION OF THE PREFERRED EMBODIMENTS

Below, embodiments of the present invention will be explained with reference to the drawings. The band of a received signal of an optical reception apparatus and the reception characteristics with respect to the bit rate of the received signal gently change, so strict control of the band of the received signal is not necessary. Therefore, since a high precision of detection of the bit rate is not required, it is preferable to be able to detect the bit rate by a low cost structure. According to the present invention, note was taken of the use of a low cost, known CMOS inverter for detecting the bit rate.

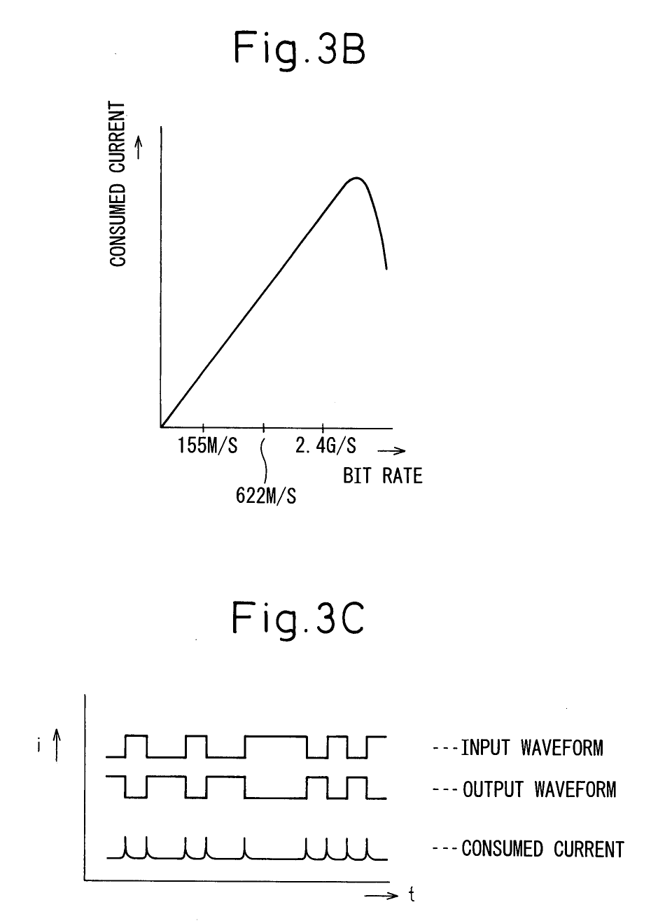

FIG. 3A is a circuit diagram for explaining the principle of the bit rate detection method according to the present invention. In FIG. 3A, a known CMOS inverter is shown. Reference numeral 31 indicates a P-channel MOS transistor, 32 an N-channel MOS transistor, 33 an input terminal, 34 an output terminal, 35 a current source connected between a power source Vcc and source of a P-channel MOS transistor 31, and 36 a current source connected between a negative power source 37 and a source of the N-channel transistor 32. In the present invention, the bit rate of the received signal is detected from the consumed current flowing through the CMOS inverter. The output of the CMOS inverter is not used.

FIG. 3B is a graph showing the relationship between the consumed current flowing through the CMOS inverter shown in FIG. 3A and the bit rate of the input signal. As shown in FIG. 3A, the bit rate is substantially proportional to the consumed current from 0 bit/sec to 2.4 Gbit/sec. This shows that the current flowing through both the P-channel MOS transistor 31 and N-channel MOS transistor 32 becomes larger the larger the bit rate only in the transitional period where the input signal switches logic between “0” and “1”. When the bit rate becomes more than 2.4 Gbit/sec, the operation reaches its limit and this proportional relationship is no longer maintained. Therefore, the maximum received bit rate able to be applied to the present invention is 2.4 Gbit/sec.

FIG. 3C is a graph showing the relationship between the input waveform and output waveform of the CMOS inverter shown in FIG. 3A and the consumed current. As will be understood from FIG. 3C, the larger the bit rate of the input waveform, the larger the consumed current. The consumed current is obtained by integration of the input waveform or output waveform. In this way, it is possible to detect the bit rate extremely inexpensively.

Next, the means for changing the received frequency band of a multirate optical reception apparatus in accordance with the detected bit rate of the received signal will be explained.

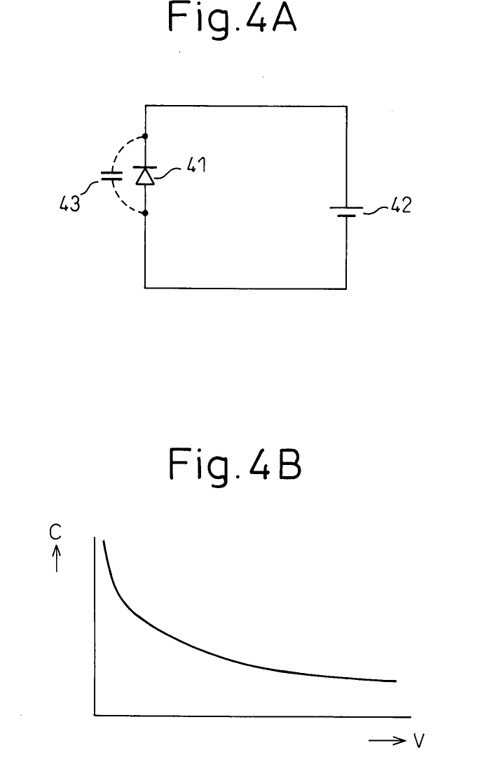

FIG. 4A to FIG. 4C are views for explaining the means for changing the frequency band width used for the first embodiment of the present invention. Among these, FIG. 4A is a circuit diagram for explaining the change in the junction capacity in the case of applying a reverse bias voltage to the PIN photodiode. In FIG. 4A, 41 indicates a PIN photodiode converting an input optical signal to an electrical signal, 42 indicates a battery for applying a reverse bias voltage, and 43 is a junction capacity attached to the PIN photodiode.

FIG. 4B is a graph showing the relationship between the reverse bias voltage from the battery 42 and the capacity of the junction capacity 43 in the circuit shown in FIG. 4A. As will be understood from FIG. 4B, the higher the reverse bias voltage V, the smaller the capacity C of the junction capacity 43.

FIG. 4C is a view showing a circuit provided with a pre-amplifier and a PIN photodiode. In FIG. 4C, 44 indicates a pre-amplifier of a gain A, 45 a negative feedback resistance of a resistance value Rf connected between the input and output of the pre-amplifier 44, 46 an input terminal, and 47 an output terminal. If the junction capacity of the PIN photodiode 41 is Cin and the gain of the pre-amplifier is A, the cutoff frequency f of this circuit can be approximated by the following equation:

$$f ≅ \frac{1}{2 π f ( \frac{Cin}{A} ) \cdot Rf}$$

Therefore, the lower the reverse bias voltage is made and the larger the junction capacity is made, the lower the cutoff frequency becomes. Due to this, it is possible to narrow the frequency band for a low bit rate to a low frequency band. Further, the higher the reverse bias voltage is made and the larger the junction capacity is made, the higher the cutoff frequency becomes. Due to this, at the time of a high bit rate, the frequency band can be broadened to the high frequency band.

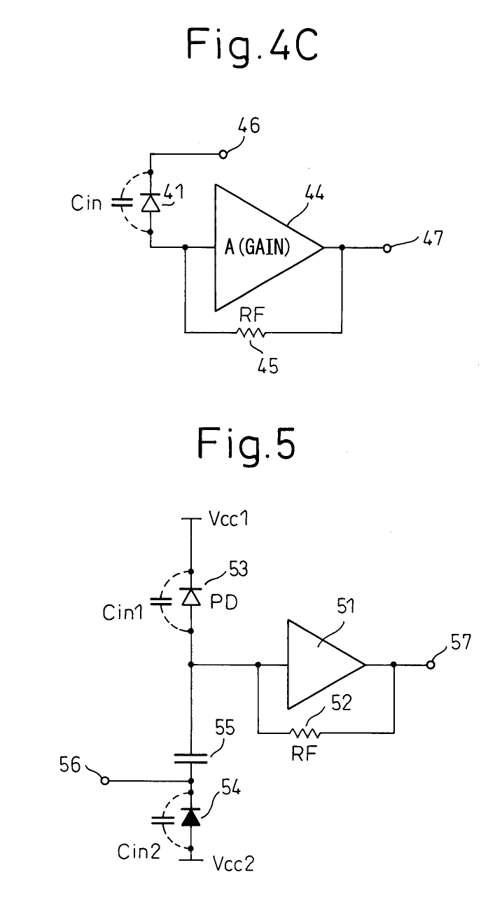

FIG. 5 is a view for explaining the means for changing the frequency band width applied to a second embodiment of the present invention. In FIG. 5, 51 indicates a pre-amplifier, 52 a negative feedback resistance of a resistance value Rf connected between the input and output of the pre-amplifier 51, 53 a PIN photodiode or avalanche photodiode converting an input optical signal to an electrical signal, 53 a variable capacity diode connected to the PIN photodiode or avalanche photodiode 53 through a DC component cut capacitor 55, 56 a control input terminal, and 57 an output terminal. The cathode of the PIN photodiode or avalanche photodiode 53 is connected to a first power source Vcc1, while the anode of the variable capacity diode 54 is connected to a second power source Vcc2. As a result, the PIN photodiode or avalanche photodiode 53 and the variable capacity diode are connected in parallel. If these junction capacities are designated as Cin₁, Cin₂ and the gain of the pre-amplifier as A, the cutoff frequency f of this circuit is determined by the following equation:

$$f ≅ \frac{1}{2 π f ( \frac{{Cin}_{1} + {Cin}_{2}}{A} ) \cdot Rf}$$

Therefore, in this case as well, by inputting a low voltage control signal to the control terminal 56 for a low bit rate, it is possible to lower the reverse bias voltage of the variable capacity diode and increase the junction capacity and thereby narrow the frequency band to the low frequency band. Further, by inputting a high voltage control signal to the control terminal 56, the higher the reverse bias voltage of the variable capacity diode and the lower the junction capacity Cin2 of the variable capacity diode, the higher the cutoff frequency. Due to this, it is possible to broaden the frequency band to the high frequency band at the time of a high bit rate.

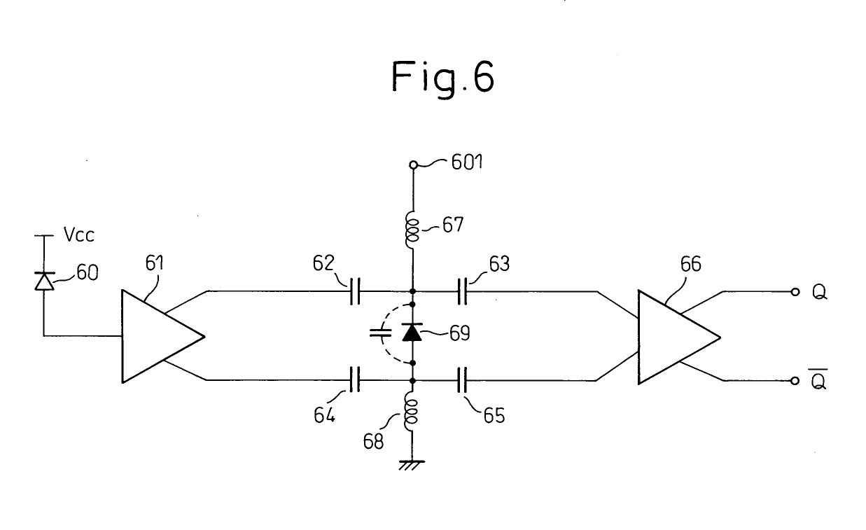

FIG. 6 is a view for explaining the means for changing the frequency band width applied to a third embodiment of the present invention. In FIG. 6, 60 indicates a PIN photodiode or avalanche photodiode converting an input optical signal to an electrical signal, 61a pre-amplifier amplifying this electrical signal, 62 to 65 capacitors cutting the DC component, 66 a post-amplifier amplifying the output of the pre-amplifier 61, 67 and 68 coils, and 69 a variable capacity diode additionally connected between the positive output and negative output of the pre-amplifier 61 through capacitors 62 and 64 according to a third embodiment of the present invention.

The cathode of the variable capacity diode 69 is connected through an inductor 67 to a control terminal 601, while the anode of the variable capacity diode 69 is grounded through the inductor 68.

In this case as well, by inputting a low voltage control signal to the control terminal 601 for a low bit rate, it is possible to lower the reverse bias voltage of the variable capacity diode 69 and increase the junction capacity and thereby narrow the frequency band to the low frequency band. Further, by inputting a high voltage control signal to the control terminal 601, the higher the reverse bias voltage of the variable capacity diode 69 and the lower the junction capacity of the variable capacity diode, the higher the cutoff frequency. Due to this, it is possible to broaden the frequency band to the high frequency band at the time of a high bit rate.

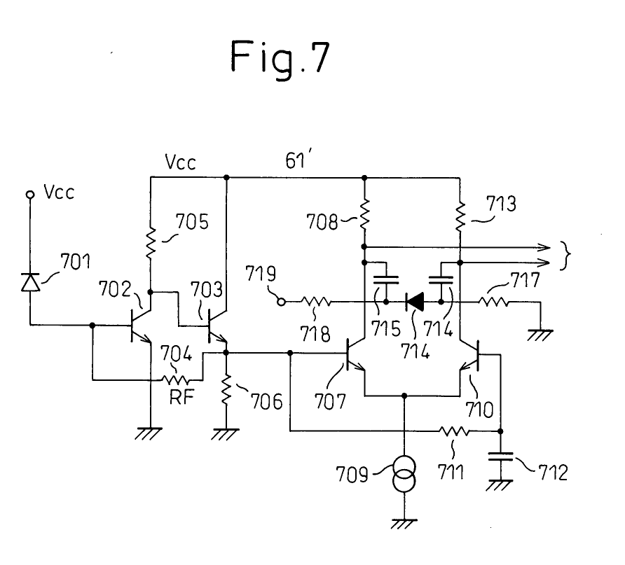

FIG. 7 is a view for explaining the means for changing the frequency band width applied to a fourth embodiment of the present invention. In FIG. 7, a pre-amplifier 61′ modified from the pre-amplifier 61 shown in FIG. 6 is shown. 701 indicates a PIN photodiode or avalanche photodiode converting an input optical signal to an electrical signal, 701 and 703 signal amplification use NPN transistors, 704 a negative feedback resistance of a resistance value Rf connected between a base of the NPN transistor 702 and an emitter of the NPN transistor 703, 705 is resistor connected between a collecter of the NPN transistor 702 and the power source Vcc, and 707 a resistor connected between an emitter of the NPN transistor and the ground. The collecter of the NPN transistor 702 is connected to a base of the NPN transistor 703, while a collecter of the NPN transistor 703 is connected to a power source.

For the pre-amplifier, a differential amplifier is used for handling an NRZ signal of a mark rate of 50%. 707 is one NPN transistor forming this differential amplifier and has a base connected to the emitter of the NPN transistor 703, a collecter connected through a resistor 708 to the power source Vcc, and an emitter grounded through the current source 709. 710 is another NPN transistor forming the differential amplifier and has a base connected through a resistor 711 to a base of the NPN transistor 707 and grounded through a capacitor 712. A collecter of the NPN transistor 710 is connected through a resistor 713 to the power source Vcc.

According to a fourth embodiment of the present invention, a variable capacity diode 714 is provided, a DC component cut capacitor 715 is connected between its cathode and a collecter of the NPN transistor 707, and a DC component cut capacitor 716 is connected between its anode and a collecter of the NPN transistor 710. An anode of the variable capacity diode 714 is grounded through a resistor 717.

By inputting a low voltage control signal to the control terminal 719 connected to the cathode of the variable capacity diode in the pre-amplifier configured in this way for a low bit rate, it is possible to lower the reverse bias voltage of the variable capacity diode 714 and increase the junction capacity and thereby narrow the frequency band to the low frequency band. Further, by inputting a high voltage control signal to the control terminal 719, the higher the reverse bias voltage of the variable capacity diode 714 and the lower the junction capacity of the variable capacity diode, the higher the cutoff frequency. Due to this, it is possible to broaden the frequency band to the high frequency band at the time of a high bit rate.

In FIG. 7, a variable capacity diode was provided in the pre-amplifier, but even if providing the variable capacity diode inside the post-amplifier instead of this, similar effects to the case of FIG. 7 can be obtained.

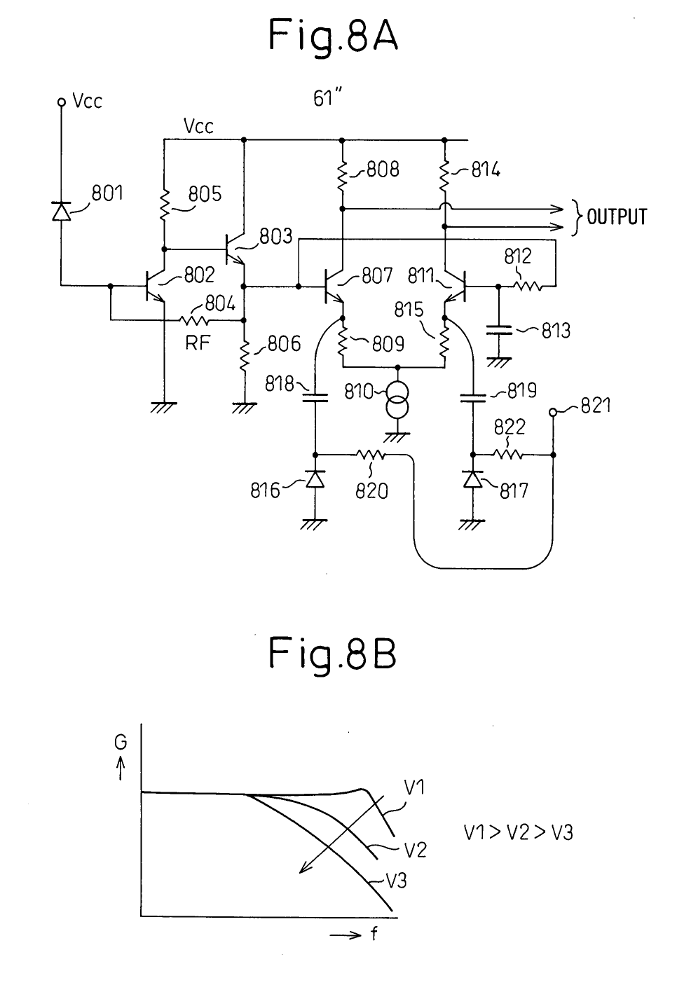

FIG. 8A is a view for explaining the means for changing the frequency band width applied to a fifth embodiment of the present invention. In FIG. 8A, a pre-amplifier 61″ modified from the pre-amplifier 61 shown in FIG. 6 is shown. 801 to 806 are the same as the elements 701 to 706 in FIG. 7.

For the pre-amplifier, in the same way as FIG. 7, a differential amplifier is used for handling an NRZ signal of a mark rate of 50%. 807 is one NPN transistor forming this differential amplifier and has a base connected to the emitter of the NPN transistor 803, a collecter connected through a resistor 808 to the power source Vcc, and an emitter grounded through the current source 809 and current source 810. 811 is another NPN transistor forming the differential amplifier and has a base connected through a resistor 812 to a base of the NPN transistor 807 and grounded through a capacitor 813. A collecter of the NPN transistor 811 is connected through a resistor 814 to the power source Vcc. An emitter is grounded through a resistor 815 and current source 810.

According to the fifth embodiment of the present invention, variable capacity diodes 816 and 817 are provided. Between the cathode of the variable capacity diode 816 and the emitter of the NPN transistor 807, a DC component cut capacitor 818 is connected. An anode of the variable capacity diode 816 is grounded. Similarly, between the cathode of the variable capacity diode 817 and the emitter of the NPN transistor 811, a DC component cut capacitor 819 is connected. An anode of the variable capacity diode 817 is grounded. A cathode of the variable capacity diode 816 is connected through a resistor 820 to a control terminal 821, while a cathode of the variable capacity diode 817 is connected through a resistor 822 to a control terminal 821.

By inputting a low voltage control signal to the control terminal 821 in the pre-amplifier configured in this way for a low bit rate, the lower the reverse bias voltage of the variable capacity diodes 818 and 819 and the larger the junction capacity of the variable capacity diode, the lower the cutoff frequency and the smaller the peaking amount of the output signal can be made.

FIG. 8B is a graph for explaining the fact that in the circuit shown in FIG. 8A, if the voltage applied to the control terminal 821 is lowered, the junction capacity becomes larger and the band width is reduced. As shown in FIG. 8B, it is learned that as the control voltage becomes the lower V1, V2, and V3, the cutoff frequency f becomes smaller. Due to this, at the time of a low bit rate, it is possible to narrow the frequency band to the low frequency band. Further, by inputting a low voltage control signal to the control terminal 821, the higher the reverse bias voltage of the variable capacity diodes 816 and 820 and the smaller the junction capacities of the variable capacity diodes, the higher the cutoff frequency and the larger the peaking amount of the gain G of the output signal can be made. Due to this, it is possible to broaden the frequency band to the high frequency band at the time of a high bit rate. However, if the reverse bias voltage is made too high, the peak gain becomes too large and the circuit may oscillate.

By the above explanation, the principle of a multirate optical reception apparatus according to embodiments of the present invention was explained.

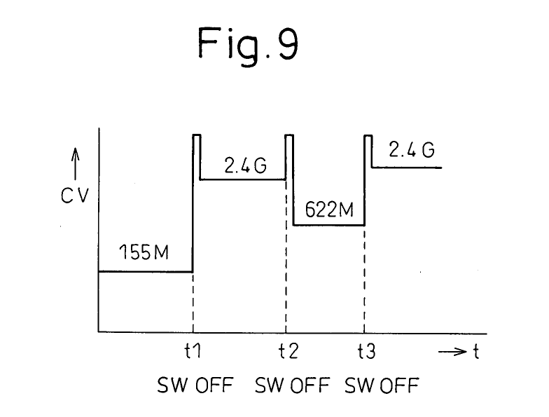

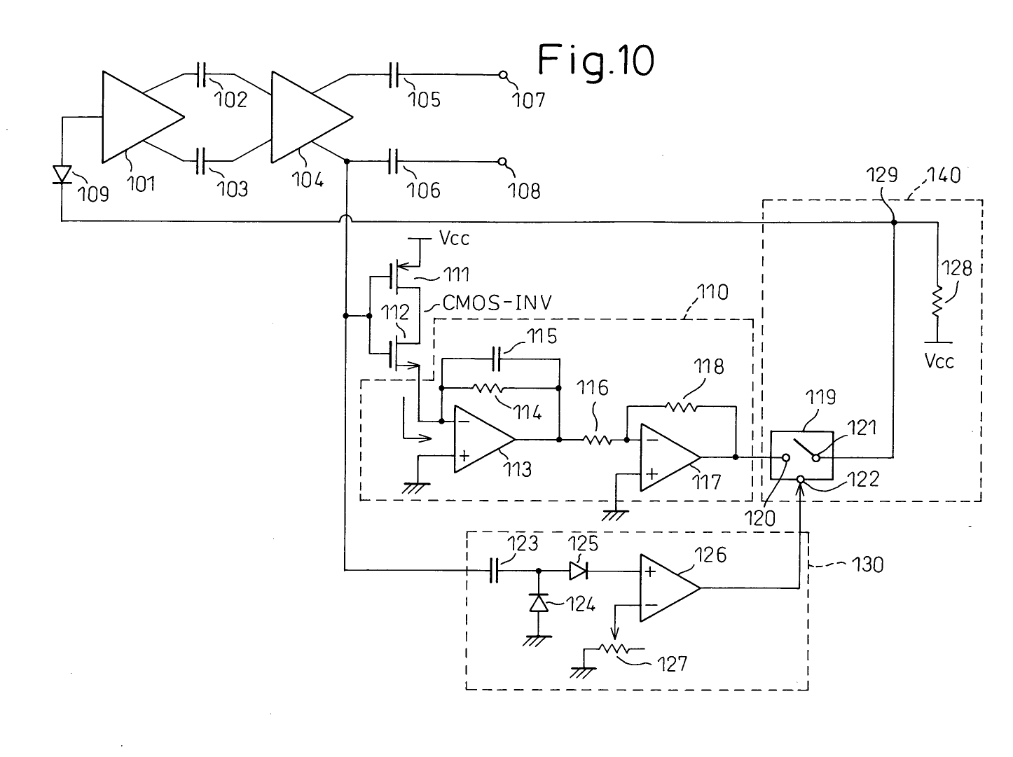

FIG. 9 is a graph showing the actual change in the control voltage for enabling multirate reception. As shown in FIG. 9, when reception of a certain frequency band ends, to enable reception of the next band, it is necessary to maximize the receivable band width after the end. In the case of FIG. 9, first, a signal of a bit rate of 155 Mbit/sec is received. At the time t1, it finishes being received and a signal-less state is entered, whereupon the analog switch SW of the circuit shown in FIG. 10 is turned off and the received band is changed to the maximum. Next, when a 2.4 Gbit/sec signal starts to be received, the control voltage CV is changed so as to give the reception band width corresponding to that bit rate. When the signal of the bit rate of 2.4 Gbit/sec finishes being received at the time t2 and the signal-less state is entered, the analog switch SW of the circuit shown in FIG. 10 is again turned off to maximize the control voltage CV and thereby change the reception band width to maximum. Next, when a 622 Mbit/sec signal starts to be received, the control voltage CV is changed to give the reception band width corresponding to that bit rate. When the signal of the bit rate of 622 Mbit/sec finishes being received at the time t3 and the signal-less state is entered, the analog switch SW of the circuit shown in FIG. 10 is again turned off to change the reception band width to the maximum. Next, when a 2.4 Gbit/sec signal starts to be received, the control voltage CV is changed so as to give a reception band width corresponding to that bit rate.

### EXAMPLE 1

FIG. 10 is a circuit diagram showing the configuration of a multirate optical signal receiving apparatus including a circuit for changing the control voltage explained in FIG. 9 according to Example 1 of the present invention. In Example 1, the reverse bias voltage applied to the PIN photodiode is changed as shown in FIG. 4. In FIG. 10, 101 indicates a pre-amplifier, 102 and 103 DC cut capacitors connected between the output of the pre-amplifier 101 and the input of the post-amplifier 104, 105 and 106 DC cut capacitors connected to the output of the post-amplifier 104, and 107 and 108 output terminals of a multirate optical signal receiving apparatus.

At the input of the pre-amplifier 101, an anode of a PIN photodiode 109 converting a received optical signal to an electrical signal is connected. The cathode of the PIN photodiode 109 is connected to a control voltage terminal 129.

One of the outputs of the post-amplifier 104 is connected to the input of the CMOS inverter CMOS-INV. The CMOS inverter CMOS-INV is comprised of a P-channel MOS transistor 111 and an N-channel MOS transistor 112. The source of the N-channel MOS transistor 112 is connected to the negative input terminal of the operational amplifier 113 forming the bit rate detection circuit 110, while the positive input terminal of the operational amplifier 113 is grounded. Between the negative input terminal and output of the operational amplifier, a negative feedback resistor 114 and DC cut capacitor 115 are connected in parallel. The output of the operational amplifier 113 is connected through the resistor 116 to the negative input terminal of the operational amplifier 117. Between the negative input terminal and output of the operational amplifier 117, a resistor 118 is connected. The positive input terminal of the operational amplifier is grounded. The output of the operational amplifier 117 is connected to the input terminal 120 of the analog switch 119.

The one output of the post-amplifier 104 which is connected to the input of the CMOS inverter is further connected through the capacitor 123 to a cathode of the diode 124 and anode of the diode 125. The capacitor 123 and the diode 124 form a clamp circuit for detecting and holding the presence/absence of a signal. When there is a signal, the cathode of the diode 124 holds the low voltage at that time. The diode 125 is for preventing back current. The cathode of the diode 126 is connected to the positive input terminal of the operational amplifier 126, while the negative input terminal of the operational amplifier 126 is connected to a control terminal of the variable resistor 127. One end of the variable resistor is grounded. By changing the position of the variable resistor, the threshold of the output voltage of the operational amplifier 126 can be changed. The output of the operational amplifier 126 is connected to the control terminal 122 of the analog switch 119. The output terminal 121 of the analog switch 119 is connected to the control voltage terminal 129. The capacitor 123, diodes 124 and 125, operational amplifier 126, and variable resistor 127 form a detection circuit 130 for detection of a signal at the output of the post-amplifier 104. A control voltage terminal 129 is grounded through a resistor 128. The elements 123 to 127 form a signal detection circuit 130 detecting a signal of the output of the post-amplifier 104. The analog switch 119, resistor 128, and control voltage terminal 129 form a control circuit 140 for controlling the reception band width.

Next, the operation of the circuit shown in FIG. 10 will be explained. If there is a signal of some sort of bit rate at the output of the post-amplifier 104, the peak voltage of the signal is held at the cathode of the diode 124. Due to this, voltage occurs at the output of the operational amplifier 126 and due to this voltage, the analog switch 119 is controlled to turn on. Due to this, a reverse bias voltage corresponding to the bit rate detected by the bit rate detection circuit 110 is applied to the PIN photodiode 109 and a frequency band suitable for that bit rate is secured.

When the output of the post-amplifier 104 enters a signal-less state, no voltage is generated at the cathode of the diode 124. Due to this, no voltage is generated at the output of the operational amplifier 126, so the analog switch 119 is controlled to turn off. Due to this, the maximum reverse bias voltage is applied to the PIN photodiode 109 and the frequency band becomes maximum.

### EXAMPLE 2

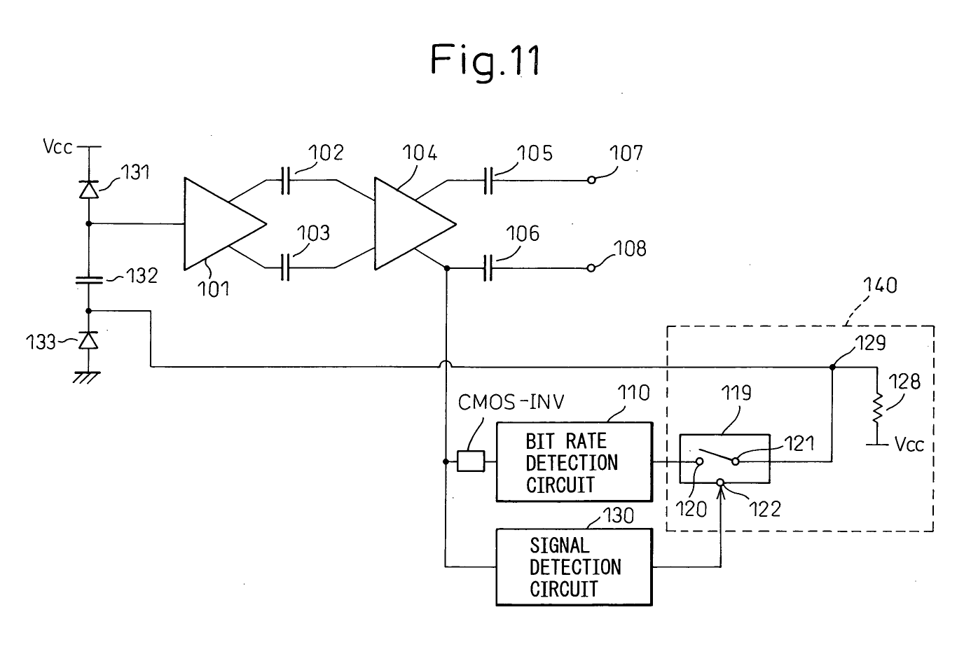

FIG. 11 is a circuit diagram showing the configuration of a multirate optical signal receiving apparatus including a circuit for changing the control voltage explained in FIG. 9 according to Example 2 of the present invention. In FIG. 11, parts the same as in FIG. 10 are assigned the same reference notations and their explanations are omitted here.

In FIG. 11, the part different from FIG. 10 is that the input of the pre-amplifier 101 is realized by the configuration shown in FIG. 5. That is, between the input of the pre-amplifier 101 and the power source Vcc, in the same way as shown in FIG. 5, an avalanche diode or PIN diode 131 converting an input optical signal to an electrical signal is connected, a cathode of the variable capacity diode 133 is connected through the capacitor 132, and an anode of the variable capacity diode 133 is grounded. The configurations of the CMOS inverter CMOS-INV, bit rate detection circuit 110, and signal detection circuit 130 are the same as those shown in FIG. 10.

By this configuration as well, the control voltage changes to give the maximum frequency band width in the periods of no signal between changes of bit rate as shown in FIG. 9 and the cutoff frequency can be changed as explained in FIG. 5 corresponding to the received bit rate at the time when there is a signal.

### EXAMPLE 3

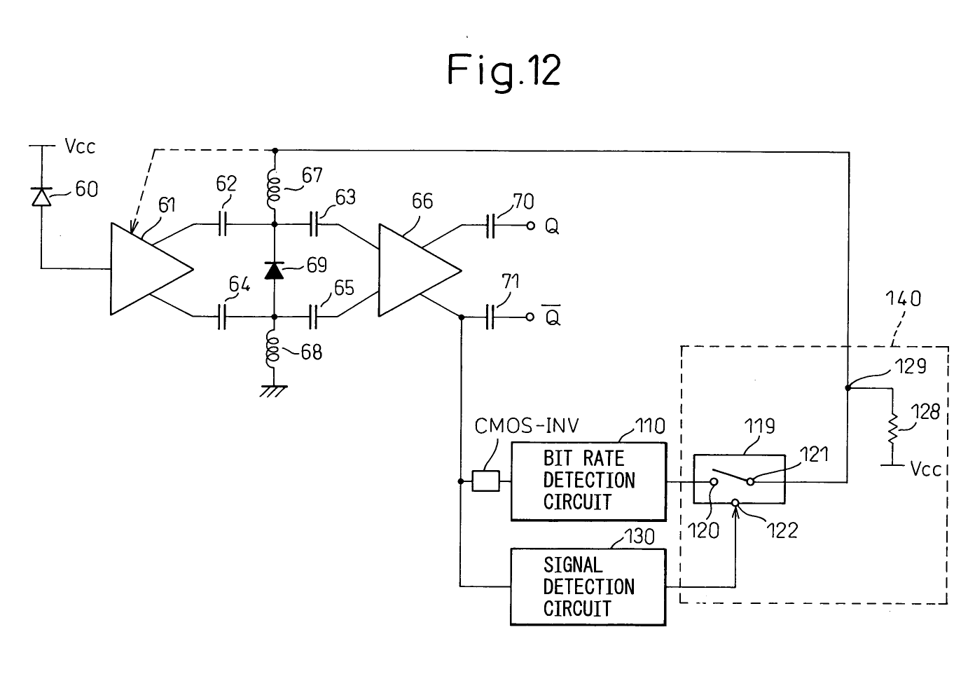

FIG. 12 is a circuit diagram showing the configuration of a multirate optical signal receiving apparatus including a circuit for changing the control voltage explained in FIG. 9 according to Example 3 of the present invention. In FIG. 12, parts the same as in FIG. 10 are assigned the same reference notations and their explanations are omitted here.

In FIG. 12, the part different from FIG. 10 is that the main part of the receiving apparatus is substantially the same as the configuration shown in FIG. 6. Parts the same as in FIG. 6 are assigned the same reference numerals. The difference from the receiving apparatus shown in FIG. 6 is that DC cut capacitors 70 and 71 are connected between the output of the post-amplifier 66 and the outputs Q and overbar Q. These DC cut capacitors 70 and 71 may be provided in the receiving apparatus shown in FIG. 6 as well. A control voltage terminal 129 is connected to a cathode of the variable capacity diode 69 through the inductor 67.

By this configuration as well, the control voltage changes to give the maximum frequency band width in the signal-less periods between changes of bit rate as shown in FIG. 9 and the cutoff frequency can be changed as explained in FIG. 6 corresponding to the received bit rate at the time when there is a signal.

### EXAMPLE 4

In the apparatus shown in FIG. 12, instead of connecting the control voltage terminal 129 to one end of the inductor 67, as shown by the broken line in FIG. 12 and as shown in FIG. 7, it is also possible to connect this to a cathode of a variable capacity diode 714 in the pre-amplifier 61 through a resistor 708. Due to this as well, the control voltage changes to give the maximum frequency band width in the signal-less periods between changes of bit rate as shown in FIG. 9 and the cutoff frequency can be changed as explained in FIG. 7.

### EXAMPLE 5

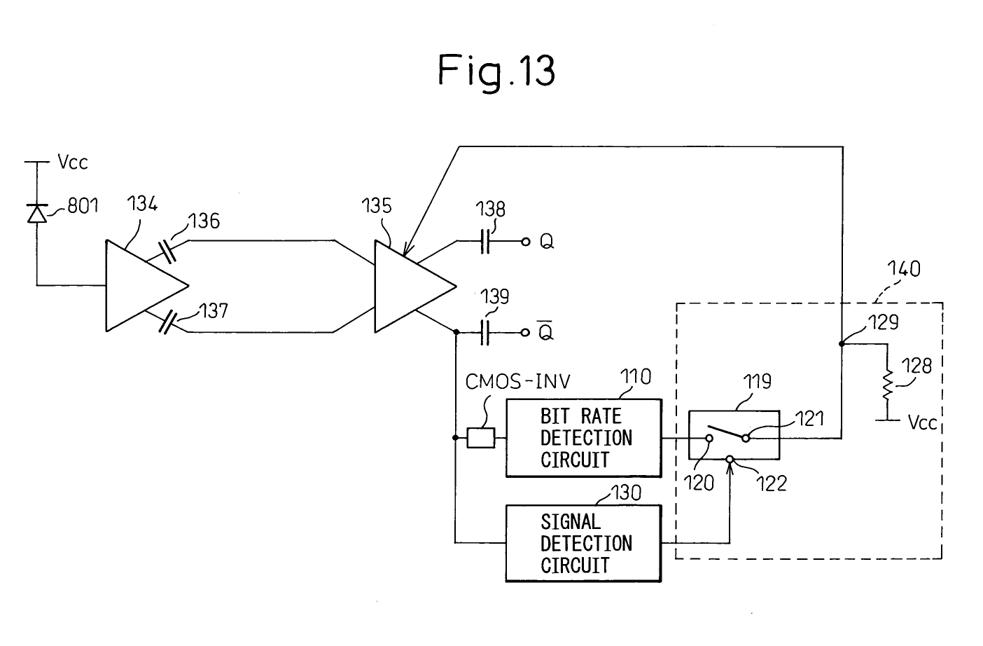

FIG. 13 is a circuit diagram showing the configuration of a multirate optical signal receiving apparatus including a circuit for changing the control voltage explained in FIG. 9 according to Example 5 of the present invention. In FIG. 13, parts the same as in FIG. 10 are assigned the same reference notations and their explanations are omitted here.

In FIG. 13, the part different from FIG. 10 is that the main part of the reception apparatus is substantially the same in configuration as shown in FIG. 8A and is configured to change the band by peaking. While not shown in detail in FIG. 13, as shown in FIG. 8A, by connecting the control voltage terminal 129 to the cathode of the variable capacity diode connected between the emitter of the transistor forming the differential amplifier and the ground, the reception frequency band can be controlled corresponding to the received bit rate.

In FIG. 13, the main part of the receiving apparatus is comprised of an avalanche diode or PIN diode 801, a pre-amplifier 134, a post-amplifier 135, DC cut capacitors 136 and 137 between the same, and DC cut capacitors 138 and 139 connected between the output terminals Q and overbar Q of the receiving apparatus of the output of the post-amplifier 135.

The control voltage terminal 129 (in FIG. 8A, the control terminal 821) is connected to the emitters of the NPN transistors forming the differential amplifier in the post-amplifier 135 (in FIG. 8A, the NPN transistors 807 and 811) (in FIG. 8, through the resistors 820 and 822).

Due to this configuration as well, the control voltage changes to give the maximum frequency band width in the signal-less periods between changes of bit rate as shown in FIG. 9 and, as explained in FIG. 8B, it is possible to raise the bias voltage of the variable capacity diode and increase the amount of peaking when the bit rate of the received signal is high and possible to lower the bias voltage of the variable capacity diode and reduce the amount of peaking when the bit rate of the received signal is low, whereby it is possible to change the width of the received frequency band in accordance with the received bit rate.

According to the present invention, there is provided an opticdal signal receiving apparatus able to detect a bit rate of a received signal at a low cost, able to change to a suitable reception band width corresponding to the received bit rate, and able to set the maximum reception band width in the signal-less state.

While the invention has been described with reference to specific embodiments chosen for purpose of illustration, it should be apparent that numerous modifications could be made thereto by those skilled in the art without departing from the basic concept and scope of the invention.

1. An optical signal receiving apparatus comprising:
a PIN photodiode converting an input optical signal to an electrical signal,
a CMOS inverter connected to an output of said PIN photodiode,
a bit rate detection circuit detecting a bit rate by the consumed current flowing through said CMOS inverter, and
a control circuit controlling the reverse bias voltage applied to said PIN photodiode based on the bit rate detected by said bit rate detection circuit.

2. An optical signal receiving apparatus as set forth in claim 1, wherein
said optical signal receiving apparatus further comprises a signal detection circuit detecting an output signal of said optical signal receiving apparatus, and
when said signal presence/absence detection circuit detects no signal, said control circuit is controlled and the maximum reverse voltage is applied to said PIN photodiode so as to maximize the reception band width.

3. An optical signal receiving apparatus comprising:
a variable capacity diode provided at any location in said optical signal receiving apparatus,
a CMOS inverter connected to the output of said optical signal receiving apparatus,
a bit rate detection circuit detecting a bit rate by a consumed current flowing through said CMOS inverter, and
a control circuit controlling the reverse bias voltage applied to said variable capacity diode based on the bit rate detected by said bit rate detection circuit.

4. An optical signal receiving apparatus as set forth in claim 1, wherein
said optical signal receiving apparatus further comprises a signal detection circuit detecting an output signal of said optical signal receiving apparatus, and
when said signal presence/absence detection circuit detects there is no signal, said control circuit being controlled to apply the maximum reverse voltage to said PIN photodiode and maximize the reception band width.

5. An optical signal receiving apparatus as set forth in claim 3,
further comprising a PIN photodiode or avalanche photodiode converting an input optical signal to an electrical signal,
said variable capacity diode being connected in parallel to said PIN photodiode or said avalanche photodiode.

6. An optical signal receiving apparatus as set forth in claim 3,
further comprising a pre-amplifier amplifying an input signal and a post-amplifier amplifying an output of said pre-amplifier,
said variable capacity diode being connected between outputs of said pre-amplifier and between inputs of said post-amplifier.

7. An optical signal receiving apparatus comprising:
a pre-amplifier amplifying an input signal,
a post-amplifier amplifying an output of said pre-amplifier,
a variable capacity diode connected between emitters of transistors in a differential amplification circuit in said pre-amplifier or said post-amplifier,
a CMOS inverter connected to an output of said optical signal receiving apparatus,
a bit rate detection circuit detecting a bit rate from a consumed current flowing through said CMOS inverter, and
a control circuit controlling a reverse bias voltage applied to said variable capacity diode based on a bit rate detected by said bit rate detection circuit.

8. An optical signal receiving apparatus as set forth in claim 7, wherein
said optical signal receiving apparatus further comprises a signal detection circuit detecting an output signal of said optical signal receiving apparatus, and
when said signal detection circuit detects no signal, said control circuit is controlled and the maximum reverse voltage is applied to said variable capacity diode so as to maximize the reception band width.

9. A multirate optical signal receiving apparatus comprising:
a pre-amplifier amplifying an input signal,
a post-amplifier amplifying an output of said pre-amplifier,
a variable capacity diode connected to collectors of transistors in a differential amplification circuit in said pre-amplifier or said post-amplifier,
a CMOS inverter connected to an output of said optical signal receiving apparatus,
a bit rate detection circuit detecting a bit rate from a consumed current flowing through said CMOS inverter, and
a control circuit controlling a reverse bias voltage applied to said variable capacity diode based on a bit rate detected by said bit rate detection circuit.

10. A multirare optical signal receiving apparatus as set forth in claim 9, wherein
said optical signal receiving apparatus further comprises a signal detection circuit detecting an output signal of said optical signal receiving apparatus, and
when said signal detection circuit detects no signal, said control circuit is controlled and the maximum reverse voltage is applied to said variable capacity diode so as to maximize the reception band width.
